(19) United States
(12) Patent Application Publication
(10) Pub. No.: US 2011/0208566 A1
(43) Pub. Date: Aug. 25, 2011

(54) Sales management system using a character recognition technique, and sales management method using same

(75) Inventor: Ki Jun Lee, Daejeon (KR)

(73) Assignee: Sevensystem Co., Ltd, Daejeon (KR)

(21) Appl. No.: 12/921,194

(22) PCT Filed: Nov. 11, 2009
(86) PCT No.: PCT/KR2009/006599

§ 371 Date: Sep. 7, 2010

(30) Foreign Application Priority Data
Nov. 12, 2008 (KR) 10-2008-0111985

(51) Int. Cl. G06Q 10/00

(52) U.S. Cl. 705/7.39

(57) ABSTRACT

The present invention relates to a sales management system using a text recognition technique, including a business card input device for inputting a business card of a customer; a text recognition server for recognizing and classifying information of the inputted business card; a customer database (DB) for storing the classified information; a sales process presentation server for fetching the information from the customer DB and presenting each step of a sales process corresponding to the retrieved information; a sales management server for, when the steps of the sales process presented by the sales process presentation server are selected, sequentially performing the steps and storing a result of the execution in a result DB; an obstacle factor DB for storing reasons for which the sales process is not sequentially performed in the sales management server; the result DB for storing a sales management result; a result report server for transmitting the sales management result, stored in the result DB, to a superior terminal; and a superior terminal for receiving a report on the sales management result and writing an opinion on the sales management result.

### CROSS-REFERENCE TO RELATED APPLICATION

This application claims priority to and the benefit of Korean Patent Application No. 10-2008-0111985 filed in the Korean Intellectual Property Office on Nov. 12, 2008, the entire contents of which are incorporated herein by reference.

### BACKGROUND OF THE INVENTION

(a) Field of the Invention

The present invention relates to a system and method in which a superior can manage the business performance of subordinates and make an alternative proposal in the subordinates' doing sales activities for sale of goods, such as automobiles, insurance, and pharmacy. The present invention is related to a sales management system and method using online and closely connected with e-commerce.

Further, the present invention relates to a system for recognizing, classifying, and storing pieces of information written in customers' business cards owned by a sales representative and performing a sales process using the information and thus it is closely related with text recognition techniques.

(b) Description of the Related Art

Marketing and sales have long been settled down as indispensable activities for the survival of companies. It can be said that marketing is a very static and rational business in that a market situation is checked through available objective data and scientifically analyzed in order to utilize it in business management. On the other hand, it can be said that sales is a very dynamic and sensitive business in that the sales staff has to visit clients and enter into business with the clients. Sales representatives suffer from severe sales stress because they have to continuously deal with customers in order to achieve their performances assigned thereto.

Another factor to cause non-ignorable stress to the sales representatives can include an evaluation for performance from their superiors. In many companies, meetings are opened in the morning and evening in order to encourage sales representatives to achieve their performance. Sales representatives having a poor business performance suffer from awful stress from theirs superiors.

Meanwhile, most sales representatives spare a lot of time in writing business-related reports to be reported to their sensors in the meetings. The report includes the number of customers, prospect customers, analyses of the needs of prospect customers, detailed future business plans, etc. Further, a sensor reviews a business policy on the basis of a report from a sales representative and instructs the sales representative to do business according to the business policy. The meeting is opened according to a traditional 7-step sales process and totally carried out offline.

The 7-step sales process relates to a strategy for analyzing a human's basic needs and selling goods. The process includes a prospect customer pick-out step, a telephone approach step, an opening interview step, a solution presentation step, a joining recommendation closing step, a referred leads step, and a customer post-service step. As described above, the steps are widely known to the industry. Many companies check the 7-step sales process and encourage sales representatives to achieve their performance.

The 7-step sales process is described in detail below.

The prospect customer pick-out step (i.e., the first step of the 7-step sales process) is a step of confirming a customer who is determined to be able to purchase merchandise, from among customers secured by a sale representative. If the customer is sought to be classified as a real prospect customer, the following 4 conditions must be satisfied.

1) Must have understanding of merchandise

2) Must have needs for merchandise

3) Must have purchasing power for merchandise

4) Must satisfy qualifications defined by a company

The above prospect customer is chiefly introduced through a close friend or acquaintance or directly picked out by a sale representative. The prospect customer pick-out step is the most difficult step for sales representatives. If a prospect customer is picked out inefficiently, it leads to a low business performance.

A second step is the telephone approach step. In this step, contact with a confirmed prospect customer is attempted for the first time. In general, contact methods include telephone, DM, e-mail, and a visit. A telephone contact method is chiefly used.

In this step, a sales representative concentrates his energies on making an interview appointment with a prospect customer instead of a description of merchandise.

A detailed procedure is described below.

1) Introduce himself.

2) Politely ask for a prospect customer's consent.

3) Described the purpose of a call. Here, the prospect customer is informed that a sale representative has known the prospect customer through the introduction of a third party.

4) Request a visit appointment. Here, an appointment time is suggested by the sale representative and approved by the prospect customer.

5) If the appointment is determined, the sale representative expresses thanks to the prospect customer.

6) Although the appointment is rejected, the sale representative expresses thanks for sparing the time and checks the reason.

A third step is the opening interview step. In this step, if an interview with a prospect customer is appointed through a telephone approach, the interview with the prospect customer is made for the first time. In the opening interview, greetings are exchanged, an atmosphere is formed, a company and merchandise are introduced, the necessity of the merchandise is informed, and a customer's interest is aroused. Further, information appropriate for service which will be provided in the subsequent solution presentation step and customer post-service step is gathered.

In the fourth solution presentation step, an optimum solution (i.e., an optimum product suitable for a customer) is presented to the customer with consideration taken of the customer's needs, financial power, etc. on the basis of the information gathered in the opening interview step. Furthermore, in the solution presentation step, purchase is induced through a positive description of the product. In order to induce the purchase, a method of giving a motive to the customer, such as that “most people have this problem, but there is no alternative option but to purchase the product in order to solve the problem,” is chiefly used.

A fifth step is the joining recommendation closing step. In this step, the purchase of the product is concluded with a positive and confident attitude, and a contract is made.

A sixth step is the referred leads step. In this step, customers who will become prospect customers in the future are secured. The customer has a good feeling of the product after the contract is made. Accordingly, the customer will accept a request for the introduction of other customers without hesitation. To this end, first, a friendly atmosphere is formed, and the customer is set at ease. A sales representative politely asks the corresponding customer for the introduction of other customers and acquires information about the introduced customers. Here, the business cards of the introduced customers have to be secured.

The last step is the customer post-service step. A greeting message is sent or a simple gift is offered on a birthday, a wedding anniversary, a national holiday, etc. on the basis of the acquired customer information. Further, a sales representative concentrates his energies on increasing intimacy with a customer by inquiring after the customer through periodical calls or mobile phone text service or frequently receiving complaints. Through this step, a sales representative can ask a customer for the introduction of other customers and secure information about the customers.

The 7-step sales process is performed offline, and a check of record of performance accordingly or meetings accordingly are also carried out offline. Accordingly, most sales representatives groan under a heavy burden on meetings based on the 7-step sales process. For example, when a sales representative presents a list of secured customers to his superior, the superior asks the sale representative a typical question “Who will become prospect customers in the list?”. The questioned sale representative presents a list of customers who comply with prospect customer conditions. However, the prospect customer conditions are typical even though the superior does not receive an answer from the sale representative. In a continued meeting, the superior checks whether the telephone approach step has been performed by questioning “Have you made a telephone appointment with a prospect customer?.” In response to the question, the sale representative will answer the superior that he has made the appointment or will typically explain to the superior a reason that the appointment has not been made, such as “because of running out of time”, “because of no interest”, or “because of no money”. A solution presented by the superior in response thereto is a typical one, such as “Have a visit appointment in such and such way” or “Pick out prospect customers again.”

In summary, a sales-related meeting performed by sales representatives and their superior is an indispensable matter in orders to encourage the sales representatives to increase their record of performance, but is performed in the state in which participating sales representatives and their superior already know causes and solutions. Accordingly, such a meeting is almost the waste of time. However, if such a meeting is not performed, there is a problem in that employee's record of performance cannot be increased because the employees cannot be controlled.

A document presented as a method for solving the above problems of offline sales management can include, for example, Korean Patent Registration No. 10-579635. The above patent is designed to support sales activities by promptly applying a sales-related algorithm, written by sales specialists, to sales representatives. The patent is characterized in that when a customer is registered, a group is assigned to the corresponding customer, the contents of a message corresponding to the group to which the corresponding customer belongs are read from algorithm data and displayed on a screen, and a corresponding task is performed when a user indicates affirmation for the contents of the message, and a corresponding task is performed when a user indicates a denial of the contents of the message.

However, the above patent is problematic in that a sale representative has to directly register his customers and has to be provided with an additional program for managing such registration. Further, the above patent is problematic in that sales representatives who are not accustomed to a computation task feel much difficult to utilize the sales-related algorithm of the patent because a detailed procedure and process for each step of the algorithm is not described and they have to write the same documents as a conventional document when writing reports to be reported to their superior.

That is, the above patent merely computerizes pertinent procedures performed by sales representatives and provides then in software. In particular, if problems in a step of sales representatives registering information about their customers are not solved, the technique of the above patent is of no special use.

Most sales representatives acquire customer information through business cards. It is, however, impossible for sales representatives chiefly working outside to classify and input names, addresses, contact points, companies, and positions while seeing business cards at their offices. Accordingly, it is difficult that the above sales support system is actually utilized unless the system is based on a text recognition technique for automatically recognizing the contents written in a business card.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made to solve the above problem, that is, to reduce the time taken for conventional offline sales-related meetings to be opened and to provide a sales management system and method using a text recognition technique having an advantage of further increased results by utilizing the reduced time in business.

Further, the present invention provides a system and method which is capable of fully computerizing the conventional 7-step sales process and reducing unnecessary meetings pertinent to sales management by solving not only the problem that customer information must be directly inputted in the conventional sales-related support system, but the above-described problems.

An exemplary embodiment of the present invention provides a sales management system using a text recognition technique, comprising:

a business card input device for reading a business card of a customer;

a text recognition server for recognizing and classifying information of the business card;

a customer database (DB) for storing the classified information;

a sales process presentation server for fetching the information from the customer DB and presenting each step of a sales process corresponding to the retrieved information;

a sales management server for, when the steps of the sales process presented by the sales process presentation server are selected, sequentially performing the steps and storing a result of the execution in a result DB;

an obstacle factor DB for storing reasons for which the sales process is not sequentially performed in the sales management server;

the result DB for storing a sales management result;

a result report server for transmitting the sales management result, stored in the result DB, to a superior terminal; and

a superior terminal for receiving a report on the sales management result and writing an opinion on the sales management result.

Further, the present invention provides a sales management method using a text recognition technique, comprising

reading a business card of a customer through a business card input device;

recognizing information of the business card and classifying and stored the information in a customer DB through a text recognition server;

fetching the information from the customer DB and presenting each step of a sales process corresponding to the retrieved information through a sales process presentation server;

sequentially performing the steps of the sales process, presented by the sales process presentation server, and storing a result of the execution in a result DB through a sales management server;

fetching the sales management result from the result DB and sending the retrieved sales management result to a superior terminal through a result report server; and

checking the sales management result, received from the result report server, through the superior terminal.

The system of the present invention can make new employees who are not accustomed to sales activities easily accustomed to the sales activities, and it is also expected to raise a successful record of performance. Further, the present invention can solve the disadvantages of a conventional sales management method, such as a very complicated business and a lot of time required when a superior manages the sales of subordinates.

Meanwhile, there is an advantage in that accumulated know-how according to sales business performed by senior members for a long period of time can be easily handed down to new employees and customer management can be automatically performed without additional efforts because customer information is automatically taken over and transferred when a predecessor is retired. Moreover, it is expected that obstacle factors, etc. occurring in each sales step can be standardized.

### BRIEF DESCRIPTION OF THE DRAWINGS

FIG. 1 is a flowchart illustrating a 7-step sales process;

FIG. 2 shows a schematic hardware construction of a sales management system using a text recognition technique according to an exemplary embodiment of the present invention;

FIG. 3 is an exemplary diagram of a window in which the 7-step sales process presented by a sales process presentation server can be performed; and

FIG. 4 is a flowchart illustrating a sales management method using text recognition according to an exemplary embodiment of the present invention.

### DESCRIPTION OF REFERENCE NUMERALS OF PRINCIPAL ELEMENTS IN THE DRAWINGS

| | |
|---|---|
| 1: business card input device | 2: text recognition server |
| 3: sale process presentation server | 4: sales management server |
| 5: result report server | 6: superior terminal |
| 7: customer DB | 8: obstacle factor DB |
| 9: result DB | |

### DETAILED DESCRIPTION OF THE EMBODIMENTS

Hereinafter, exemplary embodiments of the present invention are described in more detail with reference to the accompanying drawings. Terminologies, etc. used in the present invention are only illustrative to describe implementations of the present invention, and it is evident that the scope of the present invention is not limited thereto.

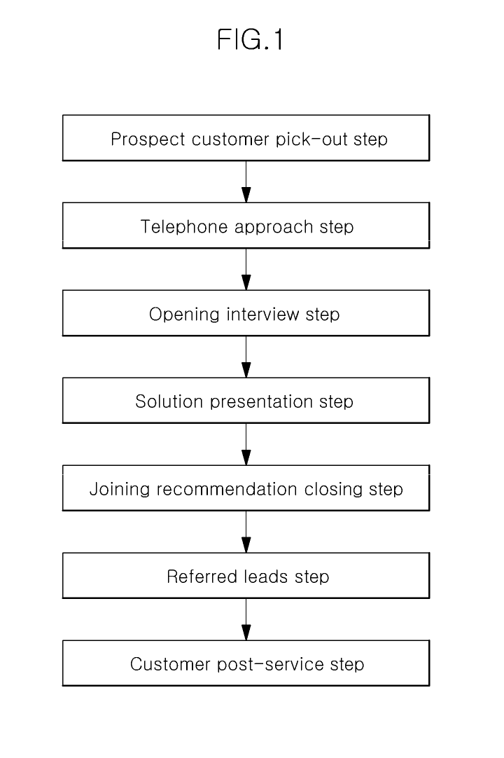

FIG. 1 is a flowchart illustrating a 7-step sales process.

As described above, the 7-step sales process is a theory which has been established by checking and analyzing a human being's merchandise purchase needs, psychology, and purchase process scientifically and systematically. The 7-step sales process consists of a prospect customer pick-out step, a telephone approach step, an opening interview step, a solution presentation step, a joining recommendation closing step, a referred leads step, and a customer post-service step. The 7-step sales process is a basis for all sales activities, such as automobile sales, sale of insurance and financial products, and pharmacy sales. Sales representatives perform sales activities according to the 7-step sales process and reports proceeding for each step to their superiors, and they are instructed to perform detailed business from the superiors.

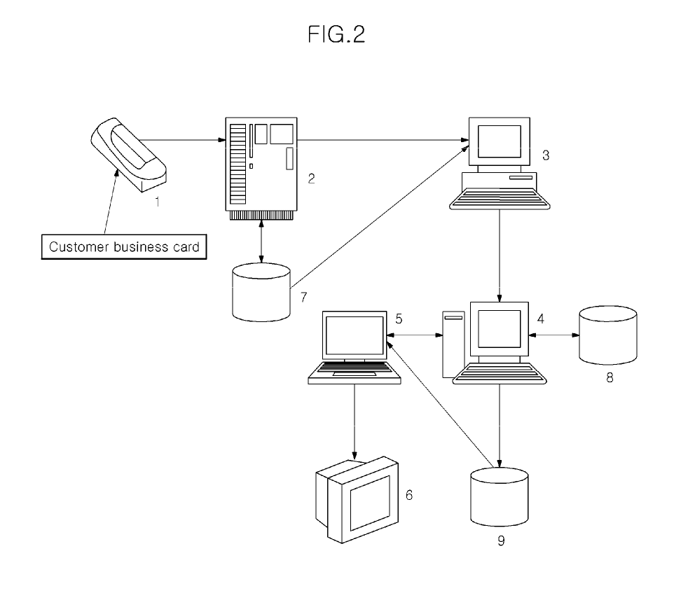

FIG. 2 shows a schematic hardware construction of a sales management system using a text recognition technique according to an exemplary embodiment of the present invention.

As shown in FIG. 2, the hardware construction according to the exemplary embodiment of the present invention includes a business card input device 1, a text recognition server 2, a customer database (DB) 7, a sales process presentation server 3, a sales management server 4, an obstacle factor DB 8, a result DB 9, a result report server 5, and a superior terminal 6.

The business card input device 1 is means for reading the business cards of customers who are introduced through another customer or directly picked out by sales representatives. The business card input device 1 can correspond to a scanner, a camera phone, and so on.

The text recognition server 2 recognizes and classifies major pieces of information, such as names, addresses, companies, positions, and contact points, on an item basis in the images of the business cards read through the business card input device 1. The text recognition server can solve a problem that sales representatives must input the contents of business cards one by one, and it is an essential constituent element which allows the system of the present invention to be utilized. Further, in order for the system of the present invention to be operated for the first time, a window in which a specific customer can be clicked is provided.

The customer DB 7 stores the customer information recognized and classified by the text recognition server.

The sales process presentation server fetches the customer information from the customer DB 7 and presents each step of the 7-step sales process corresponding to the information. For example, each step of the 7-step sales process can be described as follows.

When a specific customer from a list of customers provided by the text recognition server of the system is clicked on, a window in which the 7-step sales process can be performed is activated. For example, in case where the specific customer has been classified as a prospect customer, when a first window is clicked on, a first task is no longer activated, and a message, such as “He has already been classified as a prospect customer.” and “Please perform the telephone approach step”, is suggested.

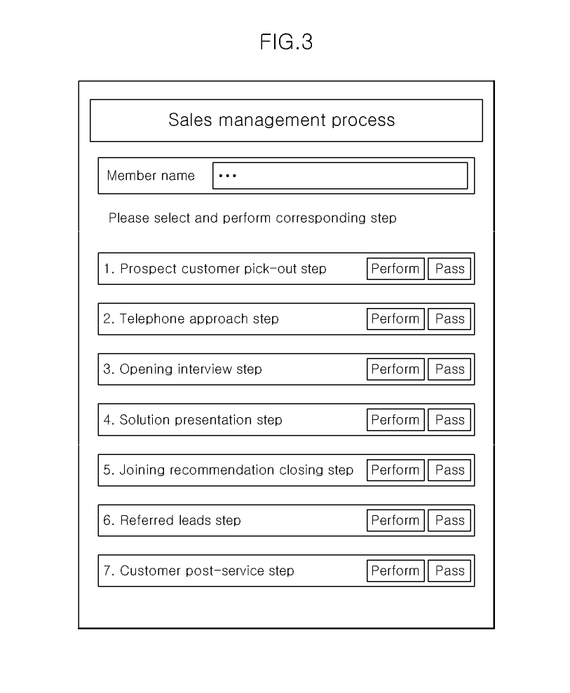

FIG. 3 is an exemplary diagram of a window in which the 7-step sales process can be performed.

Further, in case where when a sales representative performs a sales business for a specific customer (e.g., ‘Hong Gildong’), ‘Hong Gildong’ has not been classified as a prospect customer, when ‘Hong Gildong’ is clicked on, the sales process presentation server 3 activates the window in which the 7-step sales process so that the process can be performed starting from the prospect customer pick-out step (i.e., the first step).

The first step has not yet been completed. In this case, if the sales representative clicks on the telephone approach step (i.e., the second step) or the opening interview step (i.e., the third step) without knowledge of the incompleteness, a message, such as ‘The first step has not yet been completed’, is displayed, and the sales representative is guided to the execution of the first step.

When each step of the 7-sales process presented by the sales process presentation server 3 is selected, the sales management server 4 functions to sequentially perform the steps and store corresponding results in the result DB 9. Further, if the steps of the 7-step sales process are not sequentially performed, the sales management server fetches pertinent reasons from the obstacle factor DB 8 and presents the retrieved reasons.

For example, when the prospect customer pick-out step (i.e., the first step) of the presented steps of the 7-step sales process is clicked on, the above conditions of a prospect customer, together with the customer information, such as a name, an address, a company, a position, and contact points, are activated, and a message, checking whether a corresponding customer will be classified as a prospect customer, is displayed to the sales representative. When the sales representative clicks on to classify the corresponding customer as the prospect customer, the corresponding customer is classified as the prospect customer, and a result thereof is stored in the result DB 9.

Results performed every steps may be arranged on a step basis as described above or arranged comprehensively. In the case of the comprehensive arrangement, after a contract is made, a final list of customers is presented in the customer post-service step. When the sales representative clicks on a specific customer in the customer post-service step, pieces of basic information for post customer management, such as a telephone number, a birthday, a wedding anniversary, a final interview date, an expected date on which a product will be replaced, from the customer information are activated and presented to the sales representative. When the sales representative checks and clicks on the information, final sales process completion results are written, arranged, and stored in the result DB 9.

If the 7-step sales process is not normally performed and stopped, the obstacle factor DB 8 standardizes and stores reasons thereof. For example, if the opening interview step is not normally performed, such reasons as, for example, “a customer does not have time”, “a customer is unconcerned with a product”, “a customer already has another product”, and “a customer does not like a company or a sales representative” can exist. The obstacle factor DB 8 stores the reasons on a step basis. As described above, the reasons are fetched by the sales management server 4 and presented thereby.

Results of the process stored in the result DB 9 are transmitted to the superior terminal 6 via the result report server 5. A superior can check the results, write an opinion on the results or a detailed instruction in the results, and transmit it to the sales representative through e-mail, etc.

FIG. 3 is an exemplary diagram of a window in which the 7-step sales process presented by the sales process presentation server 3 can be performed. A detailed description of FIG. 3 is the same as above.

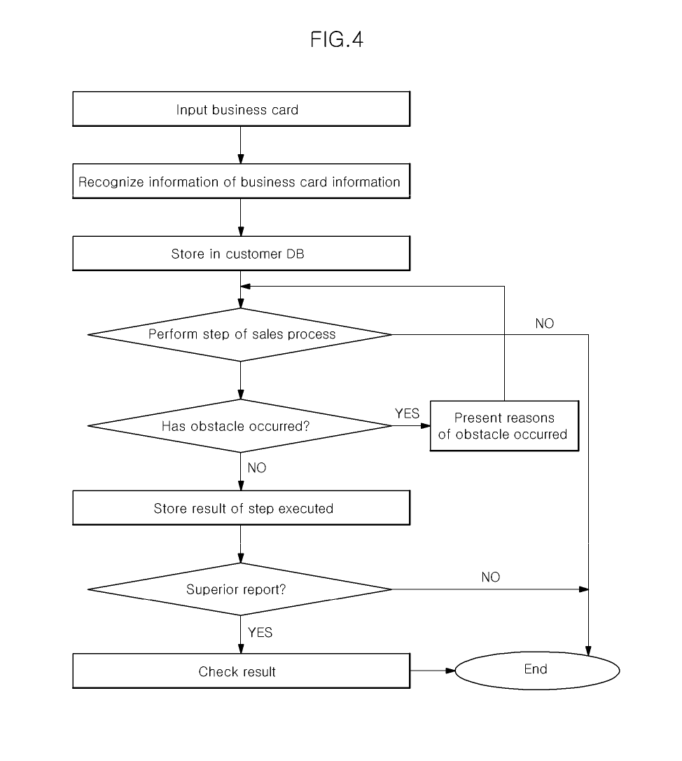

FIG. 4 is a flowchart illustrating a sales management method using text recognition according to an exemplary embodiment of the present invention. The flowchart of FIG. 4 is described in detail. When a sales representative inputs the business card of a customer through the business card input device 1, the text recognition server 2 recognizes information written in the customer's business card, such as a name, an address, a contact point, and a position, and classifies and stores them in the customer DB 7. When the sales representative clicks on a specific customer through the text recognition server 2, the sales process presentation server 3 fetches the information stored in the customer DB 7 and presents each step of the 7-step sales process. Each step of the 7-step sales process is the same as described above.

The sales management server 4 sequentially performs the steps of the 7-step sales process presented by the sales process presentation server 3, arranges results thereof on a step basis or comprehensively, and stores them in the result DB 9. If a next process is not performed during the process, the sales management server 4 fetches reasons thereof from the obstacle factor DB 8 and presents the reasons.

The result report server 5 fetches sales management results from the result DB 5 and sends them to the superior terminal 6. A superior checks the sales management results received from the result report server 5 through the superior terminal 6 and instructs the corresponding sales representative to perform a necessary task. Accordingly, the method of the present invention is completed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A sales management system using a text recognition technique, the sales management system comprising:
a business card input device for reading a business card of a customer;
a text recognition server for recognizing and classifying information of the business card;
a customer database (DB) for storing the classified information;
a sales process presentation server for fetching the information from the customer DB and presenting each step of a sales process corresponding to the retrieved information;
a sales management server for, when the steps of the sales process presented by the sales process presentation server are selected, sequentially performing the steps and storing a result of the execution in a result DB;
an obstacle factor DB for storing reasons for which the sales process is not sequentially performed in the sales management server;
the result DB for storing a sales management result;
a result report server for transmitting the sales management result, stored in the result DB, to a superior terminal; and
a superior terminal for receiving a report on the sales management result and writing an opinion on the sales management result,
wherein the sales process comprises a prospect customer pick-out step, a telephone approach step, an opening interview step, a solution presentation step, a joining recommendation closing step, a referred leads step, and a customer post-service step.

2. The sales management system of claim 1, wherein the sales management server fetches reasons on which a next step is not performed from the obstacle factor DB and presents the reasons.

3. A sales management method using a text recognition technique, the sales management method comprising:
reading a business card of a customer through a business card input device;
recognizing information of the business card and classifying and stored the information in a customer DB through a text recognition server;
fetching the information from the customer DB and presenting each step of a sales process corresponding to the retrieved information through a sales process presentation server;
sequentially performing the steps of the sales process, presented by the sales process presentation server, and storing a result of the execution in a result DB through a sales management server;
fetching the sales management result from the result DB and sending the retrieved sales management result to a superior terminal through a result report server; and
checking the sales management result, received from the result report server, through the superior terminal,
wherein when the sales process is not sequentially performed, the sales management server fetches reasons on which a next step is not performed from the obstacle factor DB and presents the reasons.
